(19) United States
(12) Patent Application Publication
(10) Pub. No.: US 2021/0405292 A1
(43) Pub. Date: Dec. 30, 2021

(54) Optical Interconnect Structure and Method for Manufacturing Same

(71) Applicant: Nippon Telegraph and Telephone Corporation, Tokyo (JP)

(72) Inventors: Yohei Saito, Tokyo (JP); Kota Shikama, Tokyo (JP); Makoto Abe, Tokyo (JP); Atsushi Aratake, Tokyo (JP)

(21) Appl. No.: 17/294,564

(22) PCT Filed: Nov. 5, 2019
(86) PCT No.: PCT/JP2019/043224

§ 371 Date: May 17, 2021

(30) Foreign Application Priority Data
Nov. 19, 2018 (JP) 2018-216256

(51) Int. Cl. G02B 6/122; G02B 6/13

(52) U.S. Cl. CPC G02B 6/1228; G02B 6/13; G02B 6/1221

(57) ABSTRACT

An optical connection structure includes a first optical waveguide, a second optical waveguide, and an optical element. The first optical waveguide includes a first light incidence/emission end face (104) formed on one end side. In addition, the second optical waveguide includes a second light incidence/emission end face formed on one end side. One end side of the first optical waveguide and one end side of the second optical waveguide are arranged facing each other. The optical element is arranged in contact with the first light incidence/emission end face and the second light incidence/emission end face between the first optical waveguide and the second optical waveguide.

### CROSS-REFERENCE TO RELATED APPLICATIONS

This application is a national phase entry of PCT Application No. PCT/JP2019/043224, filed on Nov. 5, 2019, which claims priority to Japanese Application No. 2018-216256, filed on Nov. 19, 2018, which applications are hereby incorporated herein by reference.

### TECHNICAL FIELD

The present invention relates to an optical connection structure and a method for producing the same, and more specifically relates to an optical connection structure wherein optical elements are integrated and a method for producing the same.

### BACKGROUND

In order to transfer and process large quantities of optical information quickly and at a low cost, integration of optical devices in the optical circuit is essential. Optical circuits connect a plurality of optical devices with an optical waveguide consisting of a core consisting of a portion of a substrate surface with a high refractive index and a cladding with a lower refractive index than the core. Various devices can be incorporated into such optical integrated circuits, in which optical devices are integrated into the optical circuit.

Materials for optical circuits include ferroelectric materials such as polymers, fused silica, compound semiconductors, silicon, lithium niobite. In addition, optical waveguides for constituting optical circuits include silica-based optical waveguides made mainly of fused silica on a fused silica substrate or a silicon substrate, which are mainly in practical use in the field of communication. The characteristics of silica-based optical waveguides formed on fused silica substrates include low propagation loss, high reliability and optical stability, and good workability. Further, since they are highly compatible with silica-based optical fibers, they exhibit low loss and high reliability when connected to a standard silica-based optical fiber for communication.

Currently, optical circuits (PLC: Planar Lightwave Circuits) are being developed, such as Y-branch power splitters composed of silica-based optical waveguides, Mach-Zehnder Interferometers (MZI), optical switches using MZIs, and Arrayed Waveguide Gratings (AWG). These optical circuits are key devices in photonic network systems based on Wavelength Division Multiplexing (WDM) optical transmission systems, which are recently under construction (see Non-Patent Literature 1, Non-Patent Literature 2, and Non-Patent Literature 3).

Apart from silica-based optical circuits, smaller optical circuits provided with a function using silicon, compound semiconductors, ferroelectric materials, etc. are also being developed in recent years. In order to provide the optical circuit with a function, techniques are often used in which a groove is provided in the optical circuit and an optical element in the form of a thin film is inserted into the provided groove. For example, in order to control polarization of guided light in an optical circuit, a method is often used in which a groove is provided in the optical circuit in which an optical waveguide is formed, and a waveplate imparting a desired phase difference is inserted into the groove.

For example, as shown in FIG. 18, a λ/2 waveplate 305 is inserted into a groove 304 formed in a silicon substrate 301. An optical circuit 302 is formed on the silicon substrate 301, and the optical circuit 302 is composed of a silica-based optical waveguide 303. In the silicon substrate 301 and the optical circuit 302, the groove 304 is formed extending in a direction orthogonal to the waveguide direction of the optical waveguide 303. The groove 304 has, for example, a width of 20 μm and a depth of about 150 μm to 200 μm. By inserting the λ/2 waveplate 305, which is an optical element, into the groove 304 formed in this way, the optical circuit 302 is provided with functionality.

The λ/2 waveplate 305 is formed of, for example, a polyimide stretched film. Since the refractive index of a polyimide stretched film is about 0.05, having the polyimide stretched film be of a thickness of about 15 μm lets the polyimide stretched film function as a λ/2 waveplate for light with a wavelength of 1.5 μm, which is the communication wavelength band.

Since the optical waveguide 303 on the silicon substrate 301 is birefringent, its transmission optical characteristics tend to be polarization dependent. As mentioned above, by inserting the λ/2 waveplate 305 into the groove 304, it becomes possible to compensate for the polarization dependence of the transmission optical characteristics of the optical waveguide 303 (see Patent Literature 1).

A polyimide stretched film has a fixed polarization direction. Accordingly, in an optical waveguide array in which a plurality of optical waveguides are formed on a substrate, inserting a waveplate with a different polarization direction than the adjacent optical waveguides means inserting a waveplate with a separate polarization direction for each of the optical waveguides.

For example, by using two waveplates with different polarization directions, a polarization beam splitter 400 can be made as shown in FIG. 19. The polarization beam splitter 400 is a waveguide polarization beam splitter including, formed on a substrate 401, an input optical waveguide 402, a Y-branch coupler 403 optically connected to the input optical waveguide 402, and a TE polarization waveguide 404 and a TM polarization waveguide 405 respectively connected to an output of the Y-branch coupler 403. In addition, the polarization beam splitter 400 includes, formed on the substrate 401, a 2×2 multimode interference (MMI) coupler 406 connected to the TE polarization waveguide 404 and the TM polarization waveguide 405, and a TE polarization output waveguide 407 and a TM polarization output waveguide 408 respectively connected to an output of the 2×2 MMI coupler 406.

In the upper surface of the polarization beam splitter 400, a groove 411 is formed so as to cross the TE polarization waveguide 404 and the TM polarization waveguide 405, the groove having a constant depth (specifically a depth of 150 μm to 200 μm) in a direction orthogonal to the waveguide direction of the light in the TE polarization waveguide 404 and the TM polarization waveguide 405. Into the groove 411 is inserted a λ/4 waveplate (90 degrees) 412 so as to cross the TE polarization waveguide 404 and a λ/4 waveplate (0 degrees) 413 so as to cross the TM polarization waveguide 405. The groove 411 is formed by dicing.

In the polarization beam splitter 400, the λ/4 waveplate 413 and the λ/4 waveplate 412 are inserted between the Y-branch coupler 403 and the 2×2 MMI coupler 406, whereby the TE wave is advanced 90 degrees by the λ/4 waveplate 413 and the TM wave is advanced 90 degrees by the λ/4 waveplate 412. By shifting the phases of the two light beams split by the Y-branch coupler 403 by plus and minus 90° and inputting them into the 2×2 MMI coupler 406, only TE polarized light is output by the TE polarization output waveguide 407 and only TM polarized light is output by the TM polarization output waveguide 408 (see Non-Patent Literature 1).

The waveguide polarization beam splitter mentioned above imparts the phase difference between the polarized waves by means of waveplates inserted into both arms, and is therefore able to realize a polarization beam splitter with excellent temperature characteristics. Apart from waveplates, there are also circuits provided with wave multiplexing/demultiplexing functions by the insertion of a wavelength filter, which are used in wavelength multiplex transmission and the like (see Patent Literature 2).

### CITATION LIST

### Patent Literature

Patent Literature 1: Japanese Patent No. 3501235
Patent Literature 2: Japanese Patent Laid-Open No. 10-282350

### Non-Patent Literature

Non-Patent Literature 1: Y. Hibino, “Arrayed-Waveguide-Grating Multi/Demultiplexers for Photonic Networks”, IEEE CIRCUITS & DEVICES, pp. 21-27, 2000.
Non-Patent Literature 2: A. Himeno et al., “Silica-Based Planar Lightwave Circuits”, IEEE Journal of Selected Topics in Quantum Electronics, vol. 4, no. 6, pp. 912-924, 1998.
Non-Patent Literature 3: M. ABE, “Silica-based waveguide devices for photonic networks”, Journal of the Ceramic Society of Japan, vol. 116, no. 10, pp. 1063-1070, 2008.
Non-Patent Literature 4: M. Kawachi et al., “Silica waveguides on silicon and their application to integrated-optic components”, Optical and Quantum Electronics, vol. 22, pp. 391-416, 1990.
Non-Patent Literature 5: Y. Nasu et al., “Temperature insensitive and ultra wideband silica-based dual polarization optical hybrid for coherent receiver with highly symmetrical interferometer design”, Optics Express, vol. 19, no. 26, pp. B112-B118, 2011.
Non-Patent Literature 6: T. M. Monro et al., “Analysis of self-written waveguide experiments”, Journal of the Optical Society of America B, Vol. 16, Issue 10, pp. 1680-1685, 1999.
Non-Patent Literature 7: N. Lindenmann et al., “Photonic wire bonding: a novel concept for chip-scale interconnects”, Optics Express, Vol. 20, Issue 16, pp. 17667-17677, 2012.

### SUMMARY

### Technical Problem

Incidentally, as mentioned above, in order to provide an optical circuit with functionality, an optical element is arranged in a groove formed in the optical circuit, with the width of the groove being greater than the thickness of the optical element. This is because forming a groove matching the thickness of the optical element, and arranging the optical element into such a groove, requires high precision and is exceedingly difficult. Making the groove wider than the thickness of the optical element makes it easier to form the groove, and to arrange the optical element in the groove.

For example, as shown in FIG. 20, a plate-shaped optical element 504 is arranged in a groove 503 formed in an optical circuit in which an optical waveguide 502 is formed on a substrate 501. The groove 503 is formed across the optical waveguide 502, extending perpendicular to a waveguide direction of the optical waveguide 502. The groove 503 is formed, for example, by dicing or etching. The optical element 504, composed of, for example, a comparatively widely used polyimide waveplate, is 15 μm thick and the width of the groove 503 into which it is arranged is about 20 μm. Accordingly, a gap with a width of, for example, 5 μm is formed between the side surface of the groove 503 and the optical element 504.

In this case, for example, since a portion of the groove 503 does not have an optical waveguide structure, light 511 guided by the optical waveguide 502 and emitted from a light-emission end face on the side surface of the groove 503 will be propagated with diffraction spreading, causing propagation loss. This loss is greater than the loss taking the thickness of the optical element 504 into account. In addition, when the light 511 propagating through the space of the gap enters the optical element 504, loss due to Fresnel reflection also occurs.

In the conventional system, in order to reduce propagation loss and loss due to Fresnel reflection mentioned above, an optical connection structure is adopted in which the gap as described above is filled with a refractive index matching material 505 having a higher refractive index than the core 502a of the optical waveguide 502 and the optical element 504. By filling the gap between the side surface of the groove 503 and the optical element 504 with the refractive index matching material 505, diffraction spreading of the light 511 can be suppressed to an extent, making it possible to reduce the loss.

Meanwhile, for the purpose of realizing a compact and highly functional optical module through size reduction of the optical circuit, optical circuits consisting of an optical waveguide with a large difference in refractive index between the core and the cladding have been receiving attention in recent years. An optical waveguide with a great difference in refractive index between the core and the cladding has an advantage in that the curvature radius of the curved portion of the optical waveguide that changes the waveguide direction of the optical waveguide can be made smaller, so that the optical circuit can be made smaller.

However, optical waveguides with a large difference in refractive index between the core and the cladding have a flaw in that the loss in the groove in which the optical element is arranged becomes greater, since the angle of diffraction spreading of the light emitted from the optical waveguide end of the aforementioned groove side surface takes a greater value. In order to suppress the increase in loss of an optical waveguide with a large difference in refractive index between the core and the cladding, a technique is used in which a spot size converter for increasing the mode field diameter of the guided light in the optical waveguide near the side surface of the groove is introduced, to reduce loss due to diffraction by increasing the mode field diameter.

However, since the spot size converter itself must often be of a large size in order to convert the mode field diameter to reduce loss, the circuit cannot be made smaller as mentioned above. Further, there is also a flaw in that since the optical element needs to be arranged in the location where the mode field diameter is increased to a desired value by the spot size converter, the groove must be formed with great precision, increasing the difficulty of mounting the optical element.

As described above, conventional optical circuits with integrated optical elements suffered propagation loss of light due to the gap between the end face of the optical waveguide of the optical circuit and the optical element. In order to eliminate the gap between the two when making an optical connection, there has been proposed, for example, a connection method known as “physical contact”, which causes elastic deformation due to pressure. There has also been proposed connection method known as “optical contact” in order to eliminate the gap between the two when making an optical connection, in which the connection surfaces are made as flat as possible and connection is effected by the van der Waals force. However, these connection techniques require significant costs and production time, and there was a problem in that they were impossible to apply to the space between a side surface of a structure like a groove and the side surface of an optical element.

Embodiments of the present invention were made in order to solve the aforementioned problem, and has an object of making it possible to arrange an optical element in the middle of an optical waveguide in an optical circuit with reduced propagation loss, without requiring significant costs and production time.

### Means for Solving the Problem

An optical connection structure according to embodiments of the present invention includes a first optical waveguide; a first light incidence/emission end face formed on one end side of the first optical waveguide; a second optical waveguide; a second light incidence/emission end face formed on one end side of the second optical waveguide facing the one end side of the first optical waveguide; and an optical element arranged in contact with the first light incidence/emission end face and the second light incidence/emission end face between the first optical waveguide and the second optical waveguide, wherein emitted light that is emitted from the first light incidence/emission end face and emitted light that is emitted from the second light incidence/emission end face are combined with each other.

In an example configuration of the above optical connection structure, a core of the first optical waveguide and a core of the second optical waveguide are each composed of a photocured resin.

In an example configuration of the above optical connection structure, at least one of the core of the first optical waveguide and the core of the second optical waveguide has a cross sectional-shape which becomes larger toward the optical element.

In an example configuration of the above optical connection structure, a leading end on a side of the optical element of at least one of the core of the first optical waveguide and the core of the second optical waveguide is formed in a lens shape.

In an example configuration of the above optical connection structure, a leading end on a side of the optical element of at least one of the core of the first optical waveguide and the core of the second optical waveguide is spaced apart from the optical element.

An example configuration of the above optical connection structure further includes a third optical waveguide optically connected to another end side of the first optical waveguide; and a fourth optical waveguide optically connected to another end side of the second optical waveguide, wherein the third optical waveguide and the fourth optical waveguide are composed of an optical waveguide formed in a same layer and are arranged on either side of a gap formed in the optical waveguide, and wherein the first optical waveguide, the optical element, and the second optical waveguide are arranged in the gap.

An example configuration of the above optical connection structure further includes a third optical waveguide optically connected to another end side of the first optical waveguide, wherein the second optical waveguide and the third optical waveguide are composed of an optical waveguide including a core and a cladding and being formed in a same layer, and are arranged on either side of a gap formed in the optical waveguide, and wherein the first optical waveguide and the optical element are arranged in the gap.

A method for producing the optical connection structure according to embodiments of the present invention is a method for producing an optical connection structure including a first optical waveguide; a first light incidence/emission end face formed on one end side of the first optical waveguide; a second optical waveguide; a second light incidence/emission end face formed on one end side of the second optical waveguide facing the one end side of the first optical waveguide; and an optical element arranged in contact with the first light incidence/emission end face and the second light incidence/emission end face between the first optical waveguide and the second optical waveguide, wherein emitted light that is emitted from the first light incidence/emission end face and emitted light that is emitted from the second light incidence/emission end face are combined with each other, the method including a first step of arranging optical waveguides that are arranged spaced apart from the optical element across a region in which the first optical waveguide is formed such that the optical waveguides are arranged spaced apart from each other with their light-emission directions facing the optical element; a second step of filling a space between light-emission ends of the optical waveguides and the optical element with a resin to form a resin layer; and a third step of emitting light that is input into the optical waveguide from the light-emission end to cure a portion of the resin layer through which the emitted light passes to form a core, thereby forming the first optical waveguide composed of the core.

### Effects of Embodiments of the Invention

As described above, according to embodiments of the present invention, the optical element is arranged in contact with a first light incidence/emission end face and a second light incidence/emission end face between a first optical waveguide and a second optical waveguide composed of cores, which achieves the superior effect of allowing the optical element to be arranged in the middle of the optical waveguide in the optical circuit with reduced propagation loss, without requiring significant costs and production time.

### BRIEF DESCRIPTION OF THE DRAWINGS

FIG. 1 is a cross-sectional view showing the configuration of an optical connection structure according to a first embodiment of the present invention.

FIG. 2 is a cross-sectional view showing the configuration of another optical connection structure according to a first embodiment of the present invention.

FIG. 3 is a cross-sectional view showing the configuration of another optical connection structure according to a first embodiment of the present invention.

FIG. 4 is a graph showing the results of a comparison of excess loss in a conventional case where the gap between the groove interior and the waveplate is filled with a refractive index matching material to a case where the optical connection structure according to embodiments of the present invention as described in FIG. 3 is applied.

FIG. 5 is a graph showing the results of a comparison of excess loss in a conventional case where the gap between the groove interior and the waveplate is filled with a refractive index matching material to a case where the optical connection structure according to embodiments of the present invention as described in FIG. 3 is applied.

FIG. 6 is a characteristic diagram showing a change in excess loss over irradiation time when the change in excess loss from the transmittance of signal light is calibrated in a self-written waveguide.

FIG. 7 is a graph showing the results of a comparison of excess loss in a conventional case where the gap between the groove interior and the waveplate is filled with a refractive index matching material to a case where the optical connection structure according to embodiments of the present invention is applied.

FIG. 8 is a cross-sectional view showing the configuration of another optical connection structure according to the first embodiment of the present invention.

FIG. 9 is a cross-sectional view showing the configuration of another optical connection structure according to the first embodiment of the present invention.

FIG. 10 is a cross-sectional view showing the configuration of another optical connection structure according to the first embodiment of the present invention.

FIG. 11 is a cross-sectional view showing the configuration of an optical connection structure according to a second embodiment of the present invention.

FIG. 12 is a cross-sectional view showing the configuration of an optical connection structure according to a third embodiment of the present invention.

FIG. 13 is a cross-sectional view showing the configuration of an optical connection structure according to a fourth embodiment of the present invention.

FIG. 14 is a cross-sectional view showing the configuration of another optical connection structure according to the fourth embodiment of the present invention.

FIG. 15 shows an example configuration of an optical circuit which is an application example of the optical connection structure of embodiments of the present invention.

FIG. 16 shows wavelength-dependent characteristics of insertion loss of light when using a waveplate as the optical element in an optical connection structure.

FIG. 17 is a graph showing the results of a comparison of excess loss in a case where embodiments of the present invention are applied to an optical connection structure in which a waveplate is arranged in a groove provided in the middle of an optical waveguide to a case where embodiments of the present invention are not applied.

FIG. 18 is a perspective view showing a conventional optical connection structure.

FIG. 19 is a plan view showing an example of an optical circuit using waveplates.

FIG. 20 is a cross-sectional view showing a conventional optical connection structure.

### DETAILED DESCRIPTION OF ILLUSTRATIVE EMBODIMENTS

An optical connection structure according to an embodiment of the present invention is described below.

### First Embodiment

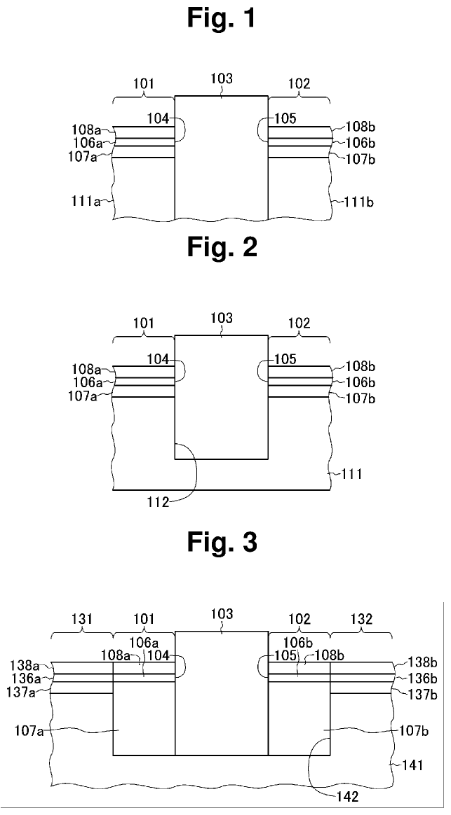

First, an optical connection structure according to a first embodiment of the present invention is described with reference to FIG. 1. This optical connection structure includes a first optical waveguide 101, a second optical waveguide 102, and an optical element 103.

The first optical waveguide 101 includes a first light incidence/emission end face 104 formed at one end side. The first light incidence/emission end face 104 is the boundary face of the interior and exterior of the first optical waveguide 101 at one end side of the first optical waveguide 101. Light that is guided from the other end of the first optical waveguide 101 will be emitted to the exterior by the first light incidence/emission end face 104. In addition, the second optical waveguide 102 includes a second light incidence/emission end face 105 formed at one end side. The second light incidence/emission end face 105 is the boundary face of the interior and exterior of the second optical waveguide 102 at one end side of the second optical waveguide 102. Light that is guided from the other end of the second optical waveguide 102 will be emitted to the exterior by the second light incidence/emission end face 105.

One end side of the first optical waveguide 101 and one end side of the second optical waveguide 102 are arranged facing each other. In addition, emitted light that is emitted from the first light incidence/emission end face 104 and emitted light that is emitted from the second light incidence/emission end face 105 are combined with each other. For example, the optical axis of the emitted light that is emitted from the first light incidence/emission end face 104 and the optical axis of the emitted light that is emitted from the second light incidence/emission end face 105 intersect each other. In addition, the optical element 103 is arranged in contact with the first light incidence/emission end face 104 and the second light incidence/emission end face 105, between the first optical waveguide 101 and the second optical waveguide 102.

The first optical waveguide 101 is composed of a first core 106a, a first lower cladding 107a, and a first upper cladding 108a. The second optical waveguide 102 is composed of a second core 106b, a second lower cladding 107b, and a second upper cladding 108b. In addition, the first optical waveguide 101 is formed on a substrate 111a, and the second optical waveguide 102 is formed on a substrate 111b. The optical connection structure is composed of the first optical waveguide 101 and the second optical waveguide 102. The first core 106a and the second core 106b are made from a photocured resin. The optical element 103 is a plate-shaped element, for example, a λ/2 waveplate.

As shown, for example, in FIG. 2, the first optical waveguide 101 and the second optical waveguide 102 are formed on the same substrate 111. By dividing one optical waveguide formed on the substrate 111 by a groove (gap) 112, the first optical waveguide 101 and the second optical waveguide 102 are formed. The groove 112 is formed in the substrate 111 to divide the optical waveguide perpendicularly to the waveguide direction of the optical waveguide. In addition, the groove 112 is formed such that its opposing side surfaces are parallel to each other.

In this case, the first light incidence/emission end face 104 and the second light incidence/emission end face 105 are arranged facing each other at the two opposing side surfaces of the groove 112 formed in the substrate 111. In addition, the optical axis of the emitted light that is emitted from the first light incidence/emission end face 104 and the optical axis of the emitted light that is emitted from the second light incidence/emission end face 105 are arranged on the same line.

Further, as shown, for example, in FIG. 3, the first optical waveguide 101, the optical element 103, and the second optical waveguide 102 are formed in a groove (gap) 142 formed in the same substrate 141. On the substrate 141, there are formed a third optical waveguide 131 and a fourth optical waveguide 132. The third optical waveguide 131 and the fourth optical waveguide 132 are formed by dividing the optical waveguide formed in the same layer on the substrate 141 with the groove 142. These optical waveguides constitute an optical circuit formed on the substrate 141. The groove 142 is formed in the substrate 141 to divide the optical waveguide perpendicularly to the waveguide direction of the optical waveguide. In addition, the groove 142 is formed such that its opposing side surfaces are parallel to each other.

The third optical waveguide 131 is composed of a third core 136a, a third lower cladding 137a, and a third upper cladding 138a. The fourth optical waveguide 132 is composed of a fourth core 136b, a fourth lower cladding 137b, and a fourth upper cladding 138b.

The first optical waveguide 101 is optically connected to the light incidence/emission end face of the third optical waveguide 131 on the side of the optical element 103. At the light incidence/emission end face of the third optical waveguide 131 on the side of the optical element 103, the first core 106a is arranged continuously with the third core 136a. In addition, the second optical waveguide 102 is optically connected to the light incidence/emission end face of the fourth optical waveguide 132 on the side of the optical element 103. At the light incidence/emission end face of the fourth optical waveguide 132 on the side of the optical element 103, the second core 106b is arranged continuously with the fourth core 136b.

In addition, the first lower cladding 107a is formed so as to fill a region below the first core 106a between the side surface of the groove 142 on the side on which the third optical waveguide 131 is arranged and the optical element 103. Likewise, the second lower cladding 107b is formed so as to fill a region below the second core 106b between the side surface of the groove 142 on the side on which the fourth optical waveguide 132 is arranged and the optical element 103.

In the optical connection structure described in FIG. 3, the optical element 103, which has a plate thickness that is thinner than the width of the groove 142 in the waveguide direction (optical axis direction) of the third optical waveguide 131 and the fourth optical waveguide 132, is arranged in the groove 142. Further, the first optical waveguide 101 and the second optical waveguide 102 are arranged between the optical element 103 and the side surface of the groove 142, and the optical element 103 is in contact with the first light incidence/emission end face 104 and the second light incidence/emission end face 105.

Therefore, the region in which the signal light suffers diffraction spreading is limited to the width of the optical element 103, and the loss is smaller than in the optical connection structure described in FIG. 20.

Further, the difference in refractive index between the first core 106a and the first lower cladding 107a and first upper cladding 108a is set to the same value as the difference in refractive index between the third core 136a and the third lower cladding 137a and third upper cladding 138a. This allows for the coupling loss between the third optical waveguide 131 and the first optical waveguide 101 due to a difference in mode field diameter to be set low.

Likewise, the difference in refractive index between the second core 106b and the second lower cladding 107b and second upper cladding 108b is set to the same value as the difference in refractive index between the fourth core 136b and the fourth lower cladding 137b and fourth upper cladding 138b. This allows for the coupling loss between phases of the fourth optical waveguide 132 and the second optical waveguide 102 due to a difference in mode field diameter to be set low.

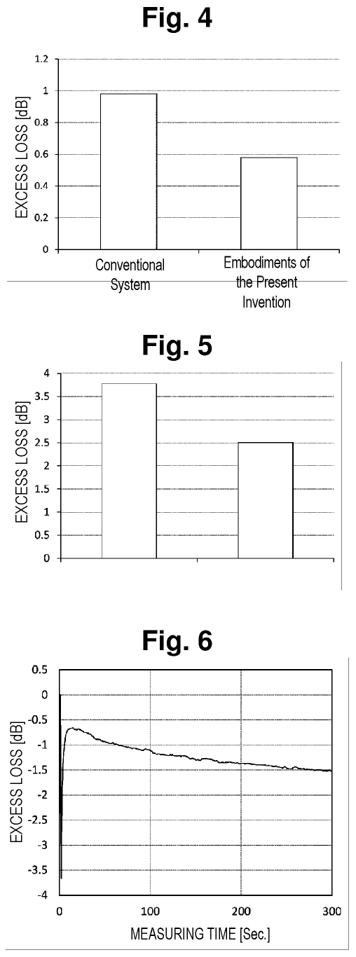

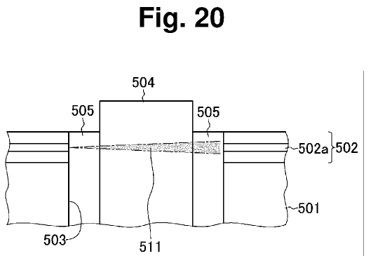

Described next are the effects of applying the optical connection structure described in FIG. 3 to the optical circuit (polarization beam splitter) described in FIG. 19. The optical circuit is composed of an optical waveguide in which the relative refractive index difference between the core and the cladding is 1.5%. The optical element consists of waveplates with a thickness of 15 μm [λ/4 waveplate (90 degrees), λ/4 waveplate (0 degrees)] which are arranged (inserted) in a groove with a width of 20 μm. The excess loss (the loss of output light power relative to input light power) in a conventional case where the gap between the groove interior and the waveplate is filled with a refractive index matching material was compared to that in a case where the optical connection structure according to embodiments of the present invention as described in FIG. 3 is applied. The results of the comparison is shown in FIG. 4. As shown in FIG. 4, it can be seen that the present invention reduces excess loss by about 0.4 dB.

Next, FIG. 5 shows the results of a similar comparison in a case where the optical circuit is composed of an optical waveguide in which the relative refractive index difference between the core and the cladding is 5%. As shown in FIG. 5, it can be seen that embodiments of the present invention reduce excess loss by about 1.2 dB.

Next, a production method of the optical connection structure according to the first embodiment of the present invention is described. This production method is a method for producing an optical connection structure as in the first embodiment described above.

First, the optical waveguides that constitute the optical circuit are arranged spaced apart from each other with their light-emission directions facing the optical element (Step 1). For example, the groove 142 described in FIG. 3 is formed by dicing or etching of the substrate 141 in which the optical waveguide is formed, namely optical waveguides constituting the third optical waveguide 131 and the fourth optical waveguide 132. Next, the optical element 103 is arranged in the formed groove 142, whereby the third optical waveguide 131 and the fourth optical waveguide 132 are arranged spaced apart from each other with their light-emission directions facing the optical element 103. In this state, the first optical waveguide 101 and the second optical waveguide 102 have not been formed, and a space is formed between the opposing surfaces of the groove 142 and the optical element 103.

Next, the space between the light-emission end of the third optical waveguide 131 and the optical element 103 is filled with a resin to form a resin layer (Step 2). The third optical waveguide 131 is an optical waveguide that is arranged spaced apart from the optical element 103 with the region constituting the first optical waveguide 101 in between. For example, the space between the opposing surfaces of the aforementioned groove 142 and the optical element 103 is filled with a resin to form a resin layer. A well-known acrylic photocured resin may be used as the resin.

Next, light that is input into the third optical waveguide 131 is emitted by the light-emission end on the side of the optical element 103, whereby the portion of the resin layer through which the emitted light (exposure light) passes is cured to form a first core 106a, thereby forming the first optical waveguide 101 (Step 3). The first optical waveguide 101 composed of the first core 106a formed in this way is known as a self-written waveguide utilizing a photocured resin (see Non-Patent Literature 6). For example, by inputting light with a wavelength band of 405 nm and an output of 5 mW, emitted by a semiconductor laser, into the third optical waveguide 131 via an optical fiber, and emitting the light from the third optical waveguide 131, the portion of the resin layer in the optical trajectory of the emitted beam is cured, forming the first core 106a. The same applies for the second core 106b. By inputting light into the fourth optical waveguide 132 and emitting the light from the light-emission end on the side of the optical element 103, the portion of the resin layer through which the light is guided is cured to form the second core 106b.

In case the optical element 103 is of a material that is transparent to the resin curing light, there is no need to input light from both waveguides, and it is possible to form the first core 106a and the second core 106b with light incident on either one of the third optical waveguide 131 or the fourth optical waveguide 132.

It is also possible to have the optical element be in contact with either one of the side surfaces of the groove (gap). In this case, the optical element is in contact with the first light incidence/emission end face on one end side of the first optical waveguide, and the third optical waveguide is optically connected to the other end side of the first optical waveguide. Further, the second optical waveguide whose second light incidence/emission end face is in contact with the optical element and the above third optical waveguide are composed of an optical waveguide including a core and a cladding and being formed in the same layer, and are arranged on either side of the groove (gap) formed in this optical waveguide. The groove is formed to divide the above optical waveguide. In addition, the first optical waveguide and the optical element are arranged in this groove.

Incidentally, when producing an optical connection structure, it is not easy to determine whether the optical element is in close contact with either one of the optical waveguide end faces (side surfaces) of the groove, or whether it is not in close contact with either side surface. Therefore, a jig or tweezers may be used to push the optical element against one side surface of the groove while filling the gap between the optical element and the other surface with resin (photocured resin) to be irradiated by a beam (exposure light) from optical waveguide at the other surface to form the core. This case is preferable from a working perspective, since there is no need to emit a beam for curing the resin from both waveguide end faces in the groove.

In addition, in the process of forming the aforementioned self-written waveguide (core), it is preferable that the self-written waveguide be formed while signal light is multiplexed into the exposure light and emitted from one optical waveguide and signal light emitted from the other waveguide is observed. Since the self-written waveguide grows sequentially from the emission end face of the light for curing the resin, the light must be continuously emitted until a self-written waveguide of a desired length is formed. In a case where the length of the self-written waveguide is 5 μm, it is difficult to confirm through an observation using a microscope that the self-written waveguide has grown to the desired length. In this regard, by observing the signal light as described above and continuously emitting the light for curing the resin until the output of the signal light reaches the maximum, it is possible to indirectly confirm that the self-written waveguide of the desired length has been formed.

Further, in order to connect the self-written waveguide to the optical waveguide with a minimum loss, there is a need to set an optimal irradiation time that matches a given irradiation power, and this is another reason why it is necessary to monitor the (transmittance of the) signal light using the aforementioned forming technique utilizing signal light to form an optimal self-written waveguide. The change in excess loss over irradiation time when the change in excess loss is calibrated from the transmittance of the signal light is shown in FIG. 6. The relative refractive index difference between the core and the cladding in the optical waveguide is 1.5%. As in the results shown in FIG. 4, it can be seen that about 0.4 dB of excess loss is recovered. In addition, as shown in FIG. 6, it can also be seen that the loss gradually increases.

In addition, when using a self-written waveguide, the portion of the resin (photocured resin) used to form the core that is not irradiated by the light can be used as the cladding. Alternatively, the uncured portion that has not been irradiated by the light can be dissolved and removed by using a solvent and the like, and a resin with a lower refractive index than the core that can be used as a cladding may be filled in the removed region to constitute the cladding.

The core composed of a photocured resin may also be formed using a writing technique in the form of a 3D photopolymerization technique (Non-Patent Literature 7). Even if the core composed of photocured resin is formed using a 3D photopolymerization technique, the effect of reduced loss in the optical connection structure can be achieved as described above.

Incidentally, the task of arranging an optical element with a thickness of 15 μm into a groove with a width of 20 μm is not easy, and even a skilled worker takes a considerable amount of time, including time for reworking of flawed products. By contrast, if the width of the groove is about 100 μm, it is easier to arrange the optical element with a width of 15 μm in the groove. According to embodiments of the present invention, propagation loss can be suppressed even if the width of the groove in which the optical element is to be arranged is increased.

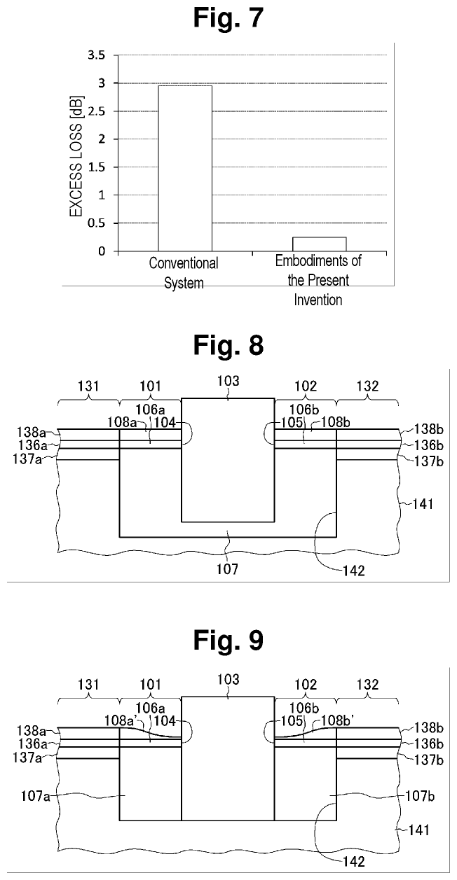

For example, described below are the effects of applying the optical connection structure according to embodiments of the present invention to the polarization beam splitter described in FIG. 19 with a 100 μm width of the groove in which the λ/4 waveplate is arranged. The optical circuit is composed of an optical waveguide in which the relative refractive index difference between the core and the cladding is 1.5%. In addition, the optical element is constituted by waveplates with a thickness of 15 μm [λ/4 waveplate (90 degrees), λ/4 waveplate (0 degrees)], which are arranged (inserted) in the groove with a width of 100 μm. FIG. 7 shows the results of a comparison of excess loss in a conventional case where the gap between the groove interior and the waveplate is filled with a refractive index matching material to a case where the optical connection structure according to embodiments of the present invention is applied. As shown in FIG. 7, when the groove in which the optical element with a thickness of 15 μm is arranged has a width of 100 μm, the conventional case exhibits a major diffraction loss of 3 dB, whereas embodiments of the present invention are able to reduce the loss to about 0.2 dB.

In the optical connection structure described in FIG. 3, the optical element 103 is in contact with the bottom of the groove 142, but the configuration is not so limited, and, as shown in FIG. 8, the optical element 103 may be arranged spaced apart from the bottom of the groove 142. In this case, the lower claddings of the first optical waveguide 101 and the second optical waveguide 102 may be composed of a resin layer 107 formed in one piece via the space between the bottom of the groove 142 and the lower surface of the optical element 103.

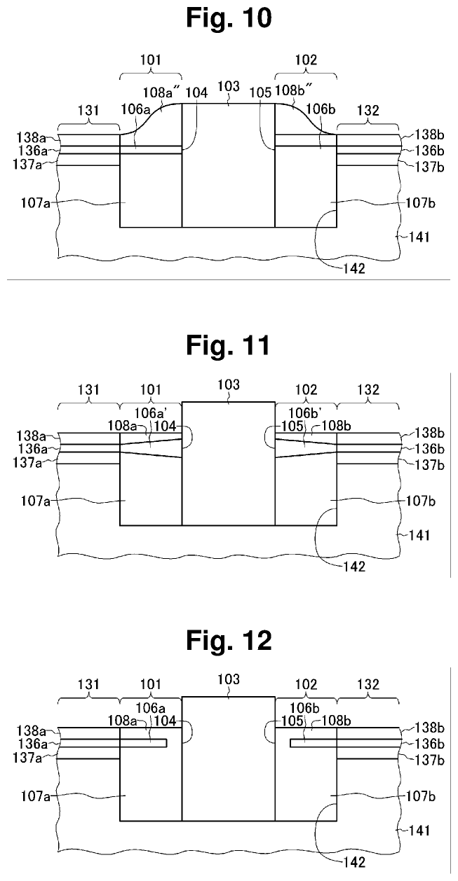

As shown in FIG. 9, the cross-sectional shape (thickness) of the first upper cladding 108a′ and the second upper cladding 108b′ of the first optical waveguide 101 and the second optical waveguide 102 may be configured to become smaller toward the optical element 103. Alternatively, as shown in FIG. 10, the cross-sectional shape (thickness) of the first upper cladding 108a″ and the second upper cladding 108b″ of the first optical waveguide 101 and the second optical waveguide 102 may be configured to become larger toward the optical element 103.

### Second Embodiment

Next, an optical connection structure according to a second embodiment of the present invention is described with reference to FIG. 11. This optical connection structure includes a first optical waveguide 101, a second optical waveguide 102, and an optical element 103. The first optical waveguide 101, the optical element 103, and the second optical waveguide 102 are formed in a groove 142 that is formed in the same substrate 141. On the substrate 141, there are formed a third optical waveguide 131 and a fourth optical waveguide 132. The configurations thereof are similar to the optical connection structure described in FIG. 3.

In the optical connection structure according to the second embodiment, the cross-sectional shape of a first core 106a′ of the first optical waveguide 101 becomes larger toward the optical element 103. In addition, in the optical connection structure according to the second embodiment, the cross-sectional shape of a second core 106b′ of the second optical waveguide 102 becomes larger toward the optical element 103. By gradually expanding the diameters of the cores toward the optical element 103 in this way, the mode field diameter of the light in the first optical waveguide 101 and the second optical waveguide 102 is expanded, making it possible to minimize the spreading angle of the light emitted from the first optical waveguide 101 and the second optical waveguide 102. This allows for suppression of diffraction spreading in the interior of the optical element 103, and enables even lower loss compared to the aforementioned first embodiment.

### Third Embodiment

Next, an optical connection structure according to a third embodiment of the present invention is described with reference to FIG. 12. This optical connection structure includes a first optical waveguide 101, a second optical waveguide 102, and an optical element 103. The first optical waveguide 101, the optical element 103, and the second optical waveguide 102 are formed in a groove 142 that is formed in the same substrate 141. On the substrate 141, there are formed a third optical waveguide 131 and a fourth optical waveguide 132. The configurations thereof are similar to the optical connection structure described in FIG. 3.

In the optical connection structure according to the third embodiment, the leading end of a first core 106a of the first optical waveguide 101 on the side of the optical element 103 is spaced apart from the optical element 103. In other words, the leading end of the first core 106a on the side of the optical element 103 recedes inwardly in the waveguide direction of the first optical waveguide 101 compared to the first light incidence/emission end face 104 that is in contact with the optical element 103. In addition, in the optical connection structure according to the third embodiment, the leading end of a second core 106b of the second optical waveguide 102 on the side of the optical element 103 is spaced apart from the optical element 103. In other words, the leading end of the second core 106b on the side of the optical element 103 recedes inwardly in the waveguide direction of the second optical waveguide 102 compared to the second light incidence/emission end face 105 that is in contact with the optical element 103. Even if the leading ends of the first core 106a and the second core 106b are spaced apart from the optical element 103 in this way, the same effect as in the aforementioned first embodiment is achieved.

### Fourth Embodiment

Next, an optical connection structure according to a fourth embodiment of the present invention is described with reference to FIG. 13. This optical connection structure includes a first optical waveguide 101, a second optical waveguide 102, and an optical element 103. The first optical waveguide 101, the optical element 103, and the second optical waveguide 102 are formed in a groove 142 that is formed in the same substrate 141. On the substrate 141, there are formed a third optical waveguide 131 and a fourth optical waveguide 132. The configurations thereof are similar to the optical connection structure described in FIG. 3.

In the optical connection structure according to the fourth embodiment, the leading end of a first core 106a of the first optical waveguide 101 on the side of the optical element 103 has a lens (convex lens) shape 109a. In addition, in the optical connection structure according to the fourth embodiment, the leading end of a second core 106b of the second optical waveguide 102 on the side of the optical element 103 has a lens (convex lens) shape 109a. The lens shapes 109a, 109b of the leading ends of the first core 106a and the second core 106b focus the light emitted from the first optical waveguide 101 and the second optical waveguide 102 to the side of the optical element 103. Therefore, diffraction loss in the interior of the optical element 103 may also be suppressed, which enables an optical connection structure with even lower loss compared to the aforementioned first embodiment.

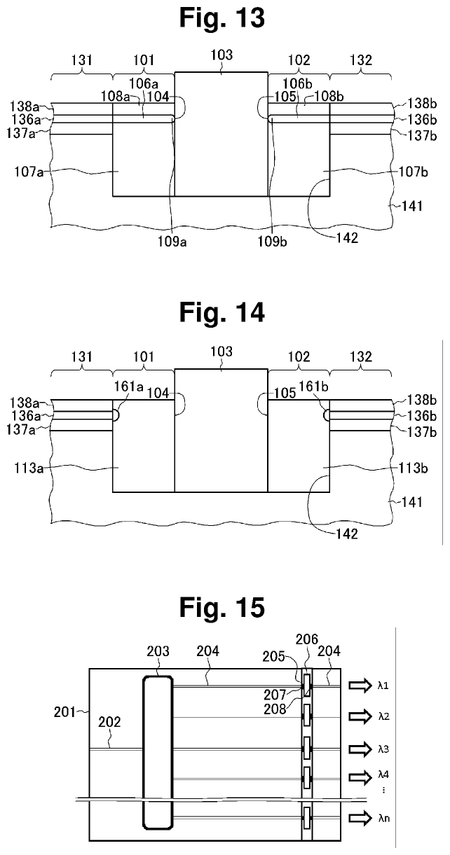

The lens shapes of the respective leading ends of the first core 106a of the first optical waveguide and the second core 106b of the second optical waveguide 102 can be formed by production methods such as, for example, the self-written waveguide or 3D photopolymerization described above. Moreover, the lens shape 109a and the lens shape 109b at the leading ends of the first core 106a and the second core 106b may also be spaced apart from the optical element 103. For example, as shown in FIG. 14, it is possible to provide the light emission ends of the third optical waveguide 131 and the fourth optical waveguide 132 on the side of the optical element 103 with a first core 161a and a second core 161b with a lens shape that protrudes toward the side of the optical element 103. In this case, cladding 113a and cladding 113b are provided to embed the first core 161a and the second core 161b and to fill the space between the opposing side surfaces of the groove 142 and the optical element 103.

Next, an application example of the optical connection structure according to embodiments of the present invention mentioned above is described with reference to FIG. 15. The optical connection structure according to embodiments of the present invention is applicable to an optical circuit for wavelength division multiplexing in which circuits integrating wavelength filters are arrayed. In this optical circuit, light input into an input optical waveguide 202 formed on a substrate 201 is split into a plurality of optical waveguides 204 by an optical splitter 203. In addition, at a predetermined location on the substrate 201 there is formed a groove 205 that extends perpendicularly to the waveguide direction of the optical waveguides 204. The plurality of optical waveguides 204 are divided by the groove 205.

The groove 205 is provided with wavelength filters 206 corresponding to each of the plurality of optical waveguides 204. Further, in the groove 205, a first optical waveguide 207 and a second optical waveguide 208 are formed between each wavelength filter 206 and the respective side surfaces of the groove 205. The light incidence/emission end faces of the first optical waveguides 207 and the second optical waveguides 208 on the side of the wavelength filter 206 are in contact with the first optical waveguide 207. By providing the first optical waveguides 207 and the second optical waveguides 208 in this way, the wavelength filters 206 can be arranged with reduced propagation loss between the wavelength filters 206 and the optical waveguides 204, and wavelength crosstalk can be reduced.

In the example described above, wavelength filters are applied as the optical element, but it is also possible to apply as the optical element a comb-shaped waveplate in which the delay imparted by the waveplate periodically changes in the longitudinal direction of the plate. A magneto-optical material may also be applied as the optical element. Using a magneto-optical material as the optical element makes it possible to realize optical circuits such as optical isolators.

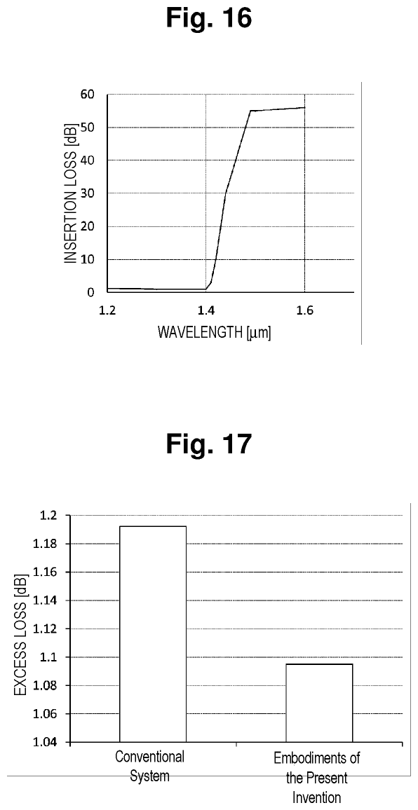

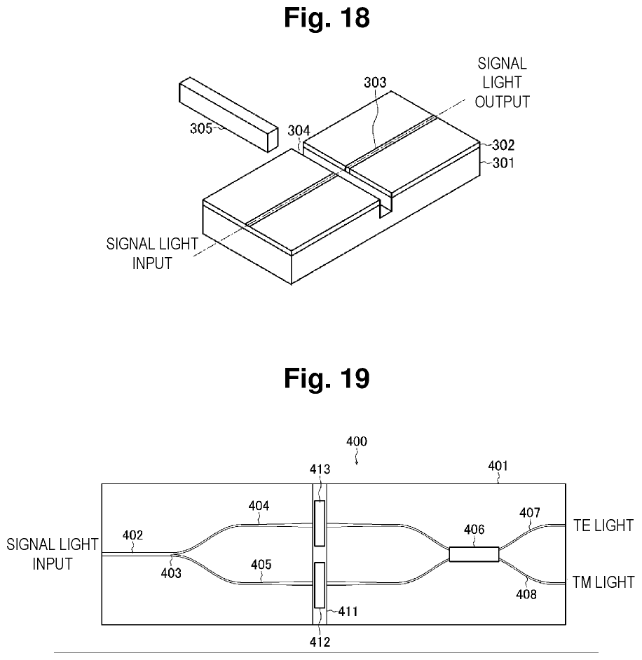

Next, wavelength-dependence of insertion loss of light when using a waveplate as the optical element is described with reference to FIG. 16. As shown in FIG. 16, arranging a waveplate as the optical element in a groove provided in the middle of an optical waveguide makes it possible to realize an optical circuit that has the effects of a wavelength filter. By applying the optical connection structure according to embodiments of the present invention to the groove in which such a waveplate (optical element) of an optical circuit is arranged, the excess loss in the groove recovers by about 0.1 dB compared to a conventional case to which embodiments of the present invention are not applied, as shown in FIG. 17.

As described above, according to embodiments of the present invention, the optical element is arranged between the first optical waveguide and the second optical waveguide composed of cores made of photocured resin, the optical element being arranged in contact with the first light incidence/emission end face and the second light incidence/emission end face, making it possible to arrange the optical element in the middle of the optical waveguide in the optical circuit with reduced propagation loss, without requiring significant costs and production time.

It will be readily apparent that the present invention is not limited to the embodiments described above, and that a person with ordinary knowledge in the art can implement several variants and combinations within the technical concept of the present invention.

### REFERENCE SIGNS LIST

101 First optical waveguide
102 Second optical waveguide
103 Optical element
104 First light incidence/emission end face
105 Second light incidence/emission end face
106a First core
106b Second core
107a First lower cladding
107b Second lower cladding
108a First upper cladding
108b Second upper cladding
111a Substrate
111b Substrate.

1.-8. (canceled)

9. An optical connection structure comprising:
a first optical waveguide;
a second optical waveguide, wherein a second light incidence/emission end face of the second optical waveguide faces a first light incidence/emission end face of the first optical waveguide; and
an optical element in contact with the first light incidence/emission end face and the second light incidence/emission end face, wherein the optical element is disposed between the first optical waveguide and the second optical waveguide, and the optical connection structure is configured to combine first emitted light that is emitted from the first light incidence/emission end face and second emitted light that is emitted from the second light incidence/emission end face.

10. The optical connection structure according to claim 9, wherein a core of the first optical waveguide and a core of the second optical waveguide are each composed of a photocured resin.

11. The optical connection structure according to claim 9, wherein a first core of the first optical waveguide or a second core of the second optical waveguide has a cross sectional-shape which becomes larger in a direction towards the optical element.

12. The optical connection structure according to claim 9, wherein a leading end on a side of the optical element of a first core of the first optical waveguide or a second core of the second optical waveguide has a lens shape.

13. The optical connection structure according to claim 9, wherein a leading end on a side of the optical element of a first core of the first optical waveguide or a second core of the second optical waveguide is spaced apart from the optical element.

14. The optical connection structure according to claim 9, further comprising:
a third optical waveguide optically connected to an opposing side of the first optical waveguide as the first light incidence/emission end face; and
a fourth optical waveguide optically connected to an opposing side of the second optical waveguide as the second light incidence/emission end face, wherein the third optical waveguide and the fourth optical waveguide are disposed at a same level, and wherein the first optical waveguide, the optical element, and the second optical waveguide are disposed between the third optical waveguide and the fourth optical waveguide.

15. The optical connection structure according to claim 9, further comprising:
a third optical waveguide optically connected to an opposing side of the first optical waveguide as the first light incidence/emission end face, wherein the second optical waveguide and the third optical waveguide each comprise a core and a cladding, wherein the second optical waveguide and the third optical waveguide are disposed at a same level, and wherein the first optical waveguide and the optical element are disposed between the second optical waveguide and the third optical waveguide.

16. A method for producing an optical connection structure, comprising:
a first step of spacing a first light-emission end of a first optical waveguide apart from an optical element such that a first space is disposed between the first light-emission end and the optical element, wherein the first light-emission end faces the optical element;
a second step of filling the first space between the first light-emission end of the first optical waveguide and the optical element with a resin layer; and
a third step of emitting a first light into the optical element from the first light-emission end to cure a first portion of the resin layer through which the first light passes to form a first core of the first optical waveguide.

17. The method according to claim 16, wherein:
the first step further comprises spacing a second light-emission end of a second optical waveguide apart from the optical element such that a second space is disposed between the second light-emission end and the optical element, wherein the second light-emission end faces the optical element, and wherein the optical element is disposed between the second light-emission end and the first light-emission end;
the second step further comprises filling the second space between the second light-emission end of the second optical waveguide and the optical element with the resin layer; and
a fourth step of emitting a second light into the optical element from the second light-emission end to cure a second portion of the resin layer through which the second light passes to form a second core of the second optical waveguide.

18. The method according to claim 16, wherein the first core of the first optical waveguide has a cross sectional-shape which becomes larger in a direction towards the optical element.
